(19) United States
(12) Patent Application Publication
(10) Pub. No.: US 2005/0197870 A1
(43) Pub. Date: Sep. 8, 2005

(54) Method of analyzing information to provide an objective assessment of a defined subject

(76) Inventors: Eric P. Canada, Wheaton, IL (US); Nancy A. Blane, Wheaton, IL (US)

Correspondence Address: BRINKS HOFER GILSON & LIONE, P.O. BOX 10395, CHICAGO, IL, 60610, US

(21) Appl. No.: 10/880,362

(22) Filed: Jun. 28, 2004

Related U.S. Application Data
(63) Continuation-in-part of application No. 09/383,352, filed on Aug. 26, 1999, now Pat. No. 6,757,660.

(51) Int. Cl. G06F 17/60; G06F 7/00

(52) U.S. Cl. 705/7

(57) ABSTRACT

A system and method is disclosed for identifying a technology bias of a company located within a community. Information is gathered regarding technology production, where the technology production includes technology that relates to technology produced by the company. Other information is gathered regarding technology absorption, where the technology absorption includes technology absorbed into a product or service of the company. Yet other information is gathered regarding technology utilization. The technology bias of the company is then identified in accordance with the quantified information about technology production, the quantified information about technology utilization, and the quantified information about technology absorption.

### RELATED APPLICATION

This application is a continuation-in-part of U.S. patent application Ser. No. 09/383,352 filed Aug. 26, 1999 (pending), which is incorporated by reference here.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Information analysis is an important tool that is used by various entities such as governments, businesses, universities and individuals, to aid in their choice of a future course of action. In this regard, entities often collect and manage huge amounts of information. Entities utilize this information in multiple endeavors such as predicting trends in the stock market, forecasting the weather, and determining whether or not a business is likely to succeed in a certain community. The value of the information utilized by the entities, however, relates directly to how well the information is analyzed. In other words, the better the analysis, the more accurately entities can predict the future event.

In one example, communities can be interested in understanding the technology related businesses in their community. The term technology is broad, however, and cuts across various industries and business sectors. Moreover, communities are often interested in evaluating the amount of Hi-technology, or Hi-tech, in the community. Hi-tech is a commonly used term, however, Hi-tech is an arbitrary indicator typically reserved for companies that produce technology for other companies. There are many companies that produce no technology but rapidly adapt technology to improve their products, services, and/or production. They are seldom considered in the definition of technology companies, but could be considered to give the community a more complete understanding of the technology related businesses in the community.

Those with an interest in attracting technology firms to a community have their own definition of what constitutes technology and consequently, a technology company. Typical behavior is to list categories of industry categories such as biotech, pharmaceutical, chemical, advanced materials, transportation, software, telecommunications, and Internet firms. Such terms, however, do not provide a way of determining a company's technological orientation. Yet understanding and cataloging technology related companies can be important for the community's leadership to determine policy, programs, and resource allocation for the community.

### BRIEF SUMMARY

A method and system are disclosed for objectively identifying a technology bias of a company within a community. Information is gathered regarding technology production, where the technology production includes technology that relates to technology produced by the company. Other information is gathered regarding technology absorption, where the technology absorption includes technology absorbed into a product or service of the company. Yet other information is gathered regarding technology utilization. The technology bias of the company is then identified in accordance with the quantified information about technology production, the quantified information about technology utilization, and the quantified information about technology absorption.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

Other features and advantages of the invention will be apparent to those skilled in the art with reference to the detailed description and the drawings, of which:

FIG. 1 shows a bar graph and a pie chart produced using known linear analysis;

FIG. 2 shows a block diagram representing the matrix analysis of the present invention, and inputs and outputs of that analysis;

FIGS. 3A-3E shows a computer input screen of an exemplary on site visit form with example information inquiries according to the matrix analysis of the present invention;

FIGS. 4A and 4B show an exemplary background report form containing information inquiries relating to the background information of the company according to the matrix analysis of the present invention;

FIG. 5 shows an exemplary post visit interviewer report that supports an analysis according to the matrix analysis of the present invention;

FIG. 6 depicts a relationship between a predefined subject, core characteristic and information inquiries according to the matrix analysis of the present invention;

FIG. 7 shows that each information inquiry may link to one or more core characteristics according to a preferred embodiment of the present invention matrix analysis;

FIGS. 8A-8D show exemplary information inquiries and weight factors for the answers to the information inquiries according to the matrix analysis of the present invention; and

FIGS. 9A-9C depict representative analysis reports according to the matrix analysis of the present invention.

FIG. 10 is a block-diagram of an exemplary system for gathering data for the cluster analysis or in preparation for a determination of a company's technology bias and a community's technology density.

FIG. 11 is a block diagram showing one way that communities can view companies within the community.

FIG. 12 is a block diagram of another way that a community can organize companies within the community.

FIGS. 13A and 13B show a questionnaire showing exemplary questions to help determine a company's technology bias.

FIG. 14 is a chart showing an exemplary way to calculate the technology bias of a company.

FIG. 15 is a block diagram showing another way that a community can organize companies.

FIG. 16 is a graph showing the technology density for a particular community.

FIG. 17 is a graph showing the technology density for another particular community.

FIG. 18 is a graph showing the technology density for another particular community.

FIG. 19 is a graph showing the technology density for a particular state or region.

FIG. 20 is a chart showing an exemplary list of categories that can be used to select companies to be evaluated for technology bias.

FIG. 21 shows a chart listing the target representation groups by percentage.

### DETAILED DESCRIPTION

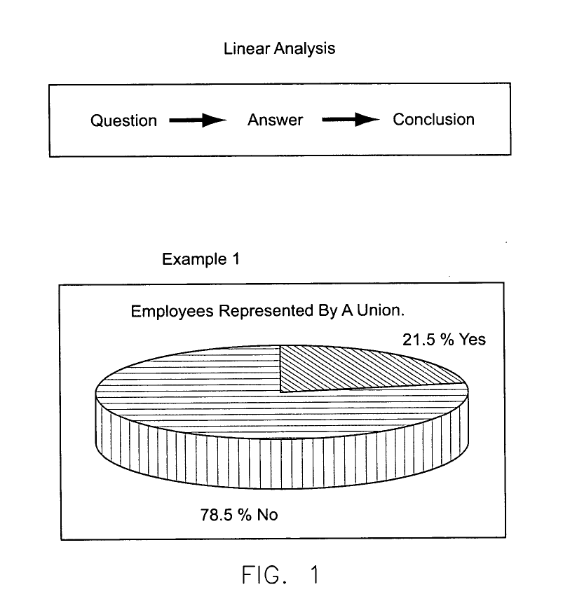

The present system and method goes beyond linear analysis that tabulates and analyzes answers to a question independently of other questions. The linear analysis typically ends with a pie chart or a bar graph representing data for a single question, as shown in FIG. 1.

The system and method analyzes data in a way that a company's technology bias is identified and technology density is calculated (e.g., beginning with FIG. 10), and/or the core characteristics for a predefined subject are answered by utilizing an array of information inquiries. The information inquiries possess differing levels of importance to determining the core characteristic. The predefined subject is a matter for thought, action, or study, such as sales, economic development, investing and key account management. It should be appreciated that, while the method of the present invention can be utilized over a wide range of predefined subjects, to simplify an explanation, the system and method are described in terms of rating whether or not a company benefits a community.

Within every predefined subject, there exists one, two, three, four or more defining elements, e.g., core characteristics. Core characteristics are often questions that cannot be addressed directly with the company's representative. For example, in equity investment, core characteristics can include management, return on equity and sales growth. As discussed herein, the core characteristics used to determine whether the company benefits the community are the company's value to the community, growth potential, technology bias, relative level of risk of a change in status, e.g., downsizing or leaving the community, and satisfaction with the community. Of course other core characteristics could be analyzed such as the company's barriers to growth in the community and marketing opportunities.

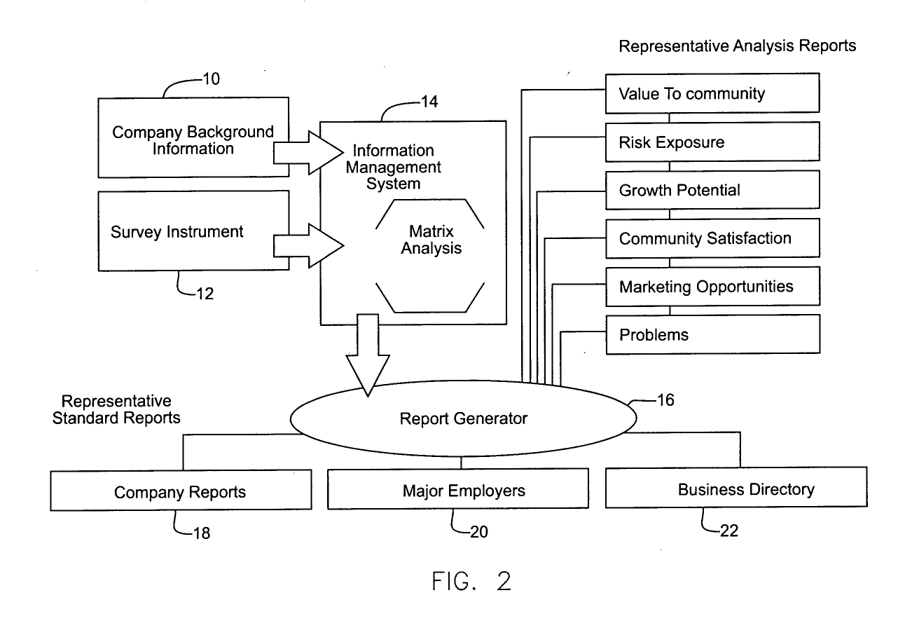

Referring to the drawings, and in particular FIG. 2, to understand the core characteristic, two types sources are shown, background information (block 10) and survey information (block 12), which gather the array of information inquiries. On the one hand, background information (block 10) includes statistics that help describe a subject and make the subject a member of a group. Typically, background information is already known or is indirectly available from various public sources. Background information includes company employment, sales volume, form of ownership and relationship to a parent company. On the other hand, survey information (block 12) focuses on the collection of information gathered from direct information inquiries, e.g., a written survey or via a personal interview, about the core characteristics of the subject.

Each information inquiry provides insight into at least one core characteristic, but no single inquiry exists where the answer will fully explain the core characteristic. As a result, many inquiries are possible, each providing only partial insight into understanding the core characteristic, and some inquiries providing more information than other questions. Preferably, the information inquiries are selected because they provide insight into at least two of the core characteristics. The order of asking the information inquiries can vary, however, it is preferred to present the information inquiries in a rational order to save time in gathering the information.

Using known survey instrument design techniques, individual questions are shaped into easily understood questions that preferably elicit consistent, reliable information from each respondent. To elicit consistent and reliable information, survey designers utilize several drafting criteria. For example, inquiries are in the form of multiple choice options or close-ended questions are formatted to insure accurate information. The information inquiries should not lead the respondent to choose one response over others. Inquiries should not threaten the respondent by asking for sensitive information. Furthermore, each question is tested and the questions are organized in a logical sequence for comfortable presentation in the survey instrument.

In addition to the above described drafting criteria, final selection of information inquiries is based on a correlation of the information inquiry with the core characteristics and the ability of the information inquiry to contribute to more than one core characteristic. Typically, the core characteristic is described in terms of direct and indirect indicators. For example, utilizing the core characteristic value to the community, information inquiries preferably should be chosen to explore both the company's direct and indirect value to the community. For direct value, the information inquiries could include total employment, total payroll, total taxes paid locally, volume of local purchases, active corporate philanthropy and growth and/or growth potential. Similarly, indirect value contributions could be measured in terms of encouraging employee involvement in the community, drawing new skilled employees and residents to the community, lending prestige to the community through a prominent role in the corporate structure and prominence in their industry.

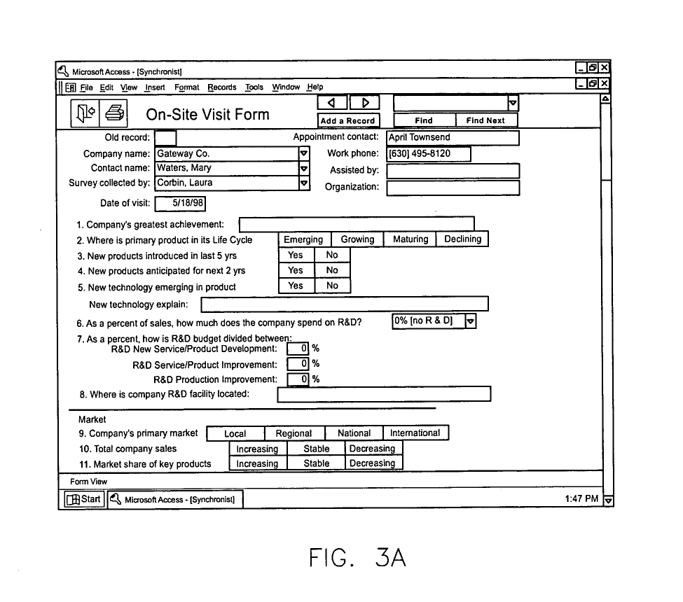

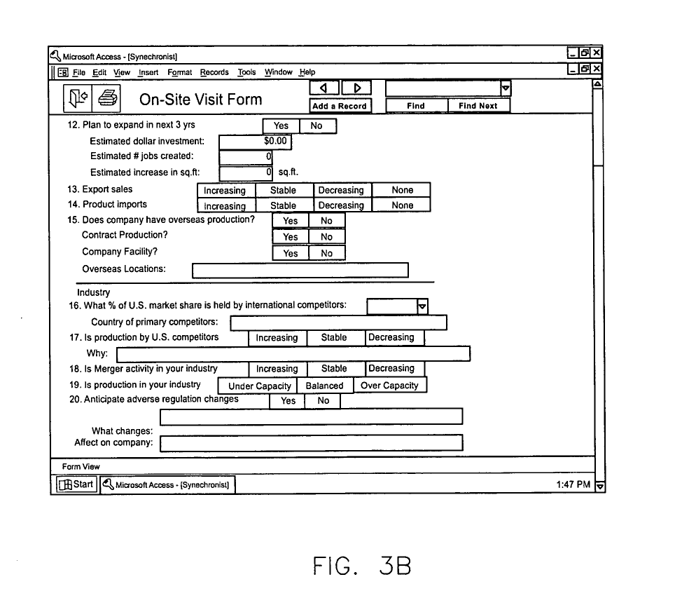

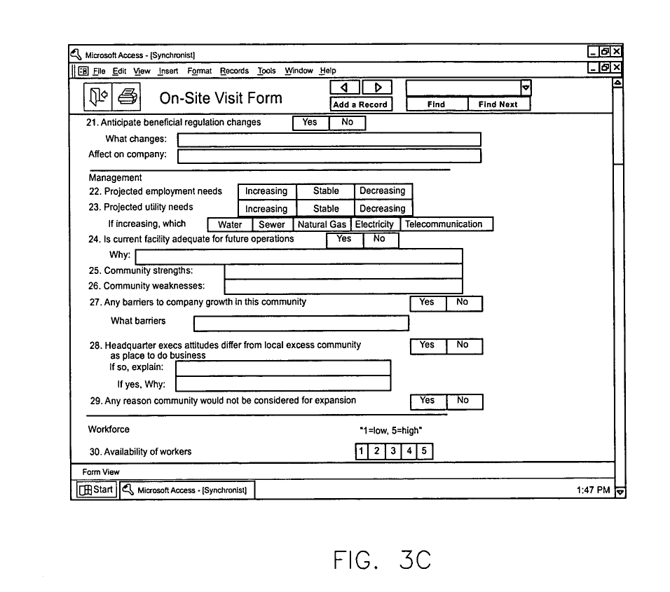

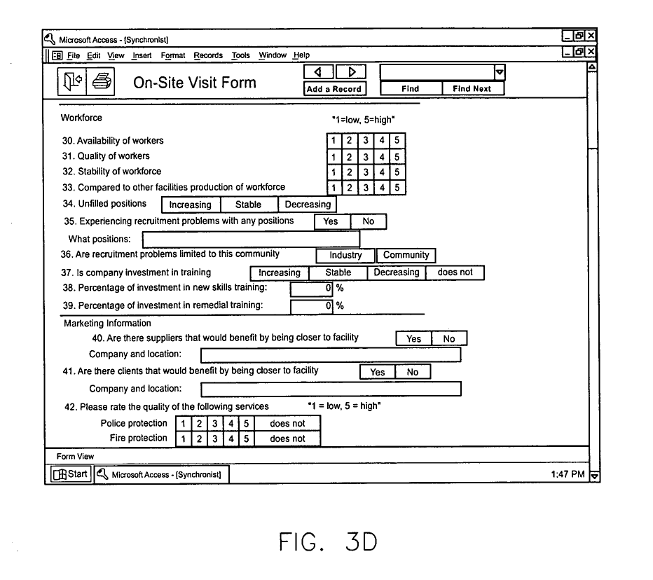

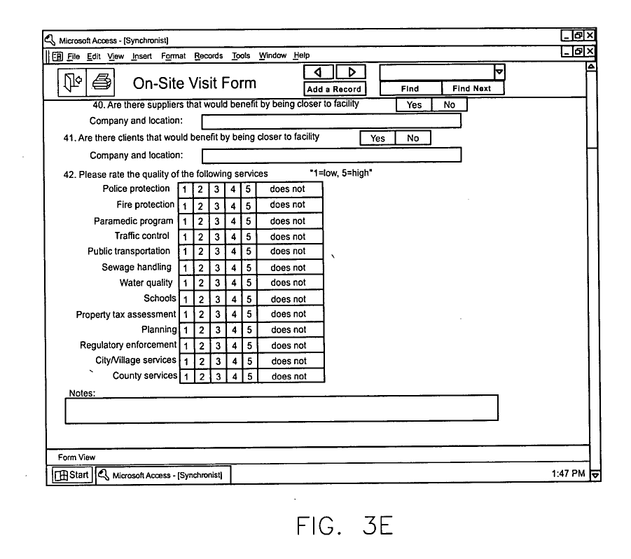

Referring to FIGS. 3A-3E, an exemplary on site visit form with example information inquiries is shown as custom built application screen shots utilizing a MICROSOFT ACCESS® platform. It can be appreciated that other forms for viewing the information inquiries and storing answers to the information inquiries are contemplated. Exemplary question one is an open-ended question which asks for the company's greatest achievement. Question two is a closed ended question which inquires about a life cycle position of the company's primary product, e.g., emerging, growing, maturing or declining. Exemplary question three is a closed ended yes/no answer question that queries whether new products have been introduced within the last five years.

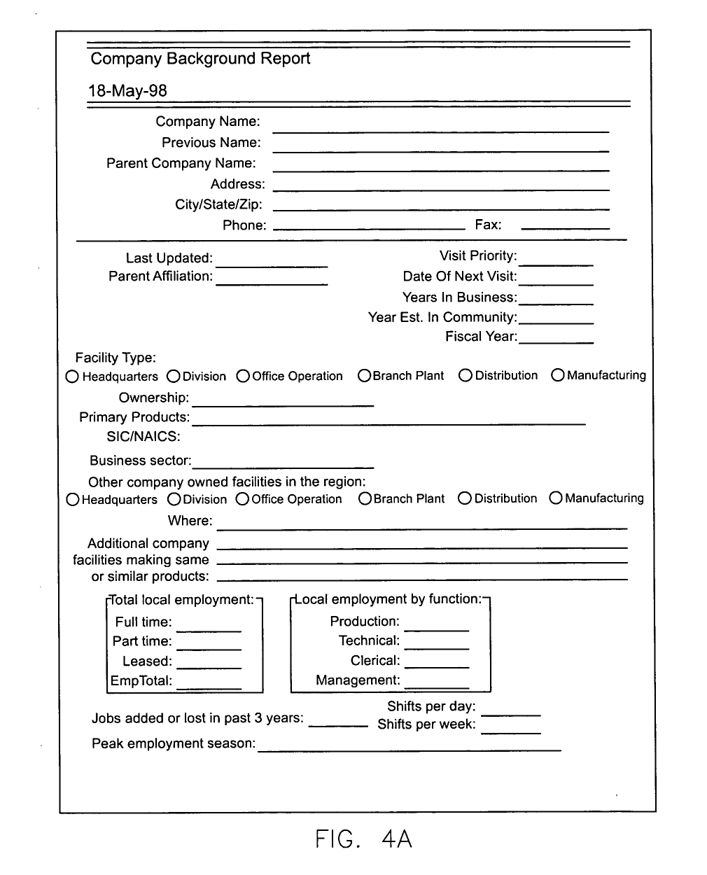

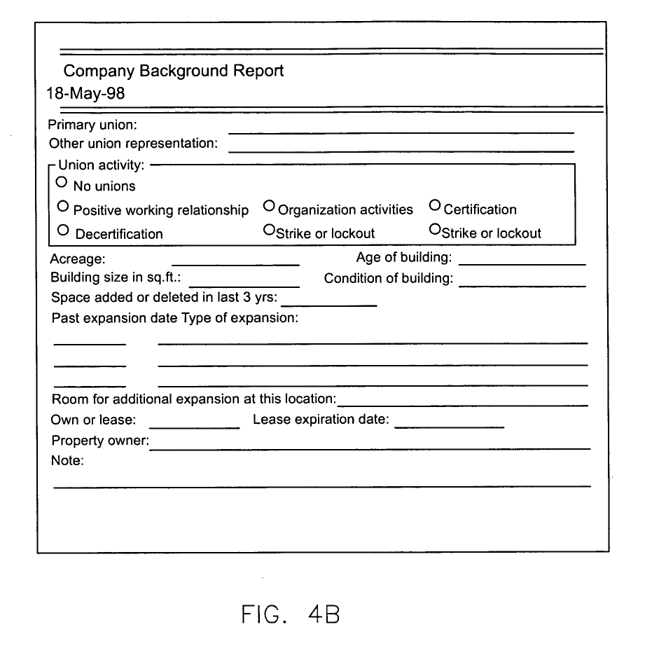

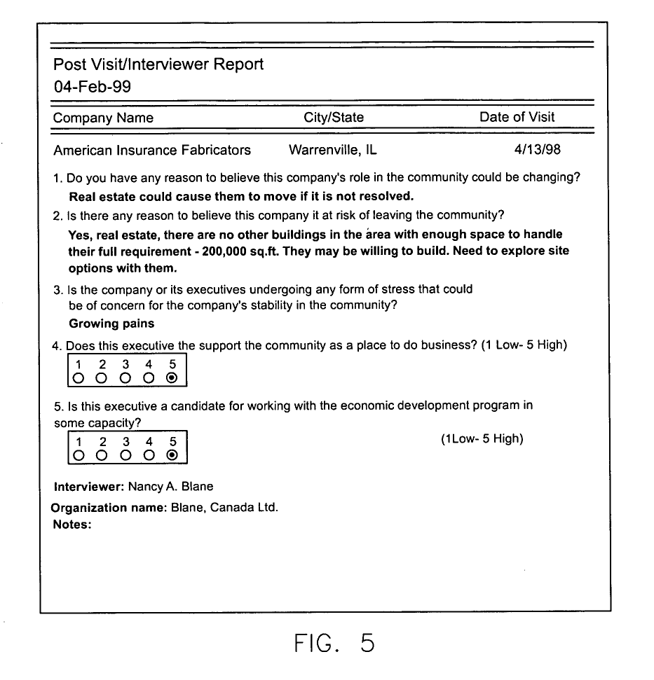

Referring to FIGS. 4A and 4B, an exemplary background report form is shown which contains information inquiries relating to the background information of the company. Background inquiries include a close-ended question about the facility type, e.g., as a headquarters, division, office operation, branch plant, distributor and manufacturer.

Referring to FIG. 5, an exemplary post visit interviewer report is shown which asks open ended and close-ended questions. An example of a close-ended question is whether an interviewed executive supports the community as a place to accomplish business. The support level is ranked from one to five, with one being a low level of support and five being a high level of support. While data from the post interviewer report is not utilized for the matrix analysis, the post interviewer report supplies users with valuable information regarding the acquisition of on site information. For example, the post visit interviewer report provides operation management functions, so that managers can experience conditions of the on site interview. In addition, the post visit interviewer report provides for follow-up tracking, e.g., a notation to obtain additional on site information.

Referring to FIGS. 3-5, the on site visit form, the background report and the post visit interviewer report combine to supply the array of information inquiries. As described below, different combinations of the information inquiries are used to describe the core characteristics. In addition, some information inquiries are only utilized as material in reports, and do not provide answers to the core characteristics, such as whether an interviewer believes the company is at risk of leaving a community (FIG. 5).

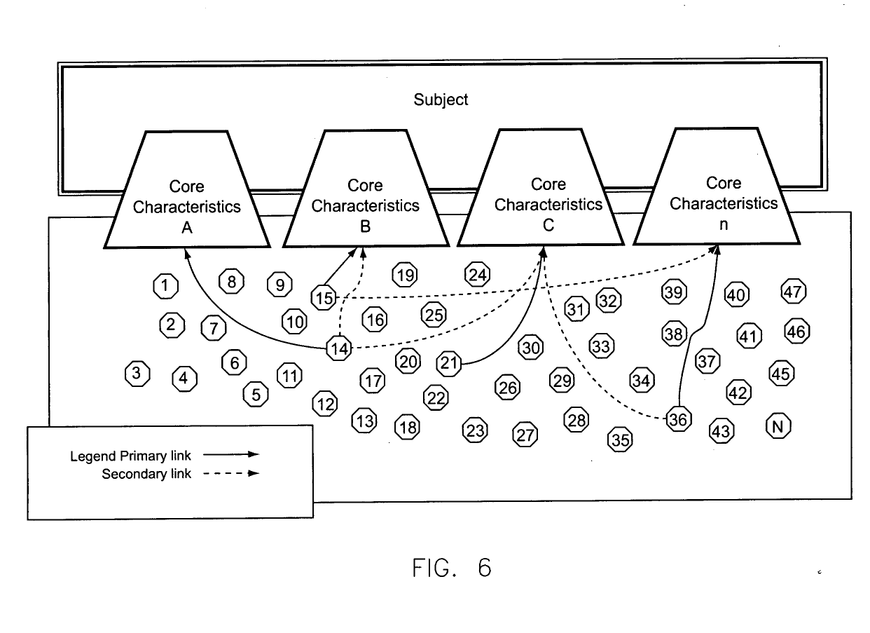

Referring to FIG. 6, a relationship is shown between a predefined subject, core characteristic A-n and information inquiries 1-N. A degree of correlation between the information inquiry 1-N and the core question A-n can be strong, weak or obtain no correlation. When the correlation is strong the inquiry links via a primary link to the corresponding core characteristic, as shown with a solid arrow. In addition, when the correlation is weak, the inquiry links via a secondary link to the corresponding core characteristic, as shown by the dashed arrow. If no correlation exists between the inquiry and the core characteristic, however, the inquiry does not link to the core characteristic.

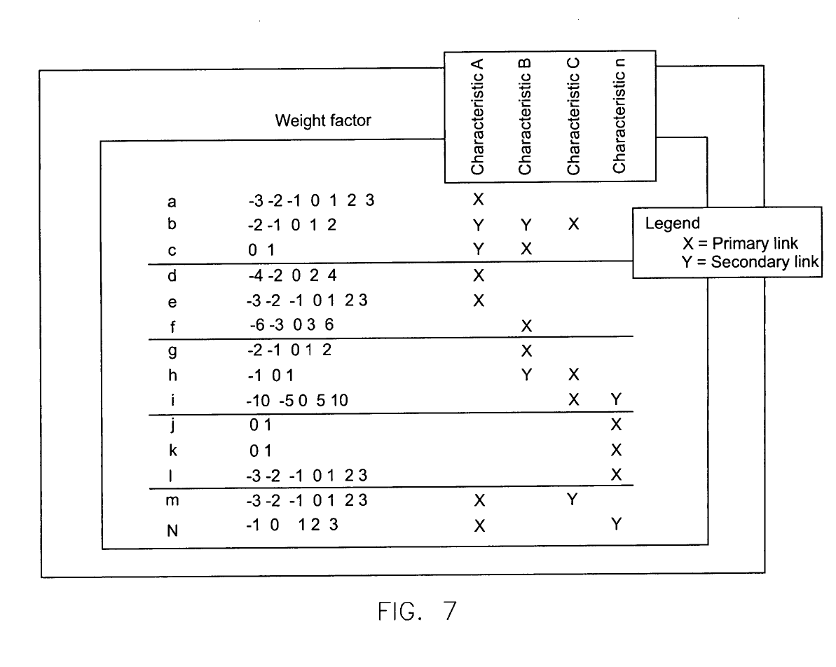

Referring to FIG. 7, it follows that each inquiry a-N may link to one or more core characteristics A-n, as shown, but do not necessarily have to link to a core characteristic. After information inquiries are conceived, they are ranked from a highest correlation to a lowest correlation, with regard to the core characteristics A-n. A range of weight factors depends of the information inquiry's level of correlation to the core characteristic A-n. Thus, an information inquiry a-N may have a wide range of weight factors, e.g., inquiry i, or a small range of weight factors, e.g., inquiry c.

In the simplest information inquiry form, a yes/no question has two different weights. If “yes” is the answer to a higher correlated inquiry, the response “yes” for that inquiry could get a weight of +5, for example. If “yes” is the desired response, a “no” response receives a lower weight. The “no” weight factor could be any number lower than +5, for example, +4, 0, or −5. Since some inquiries have a higher correlation to the core characteristic, a proper weighting range is selected to reflect the inquiry's appropriate level of influence compared to other inquiries considered in the analysis. A total number of inquiries contributing to the understanding of a core characteristic also help to determine the weight factor range for each inquiry a-N.

Referring back to FIG. 2, a matrix analysis (block 14) is performed to determine normalized values for each core characteristic. In a preferred embodiment, the matrix analysis is accomplished with a computer, for example, using the routine disclosed in the attached appendix. In addition, a database provides a convenient way to capture information and keep the information segmented. Of course, other methods of performing the matrix analysis are possible such as accomplishing the matrix analysis in an operators head.

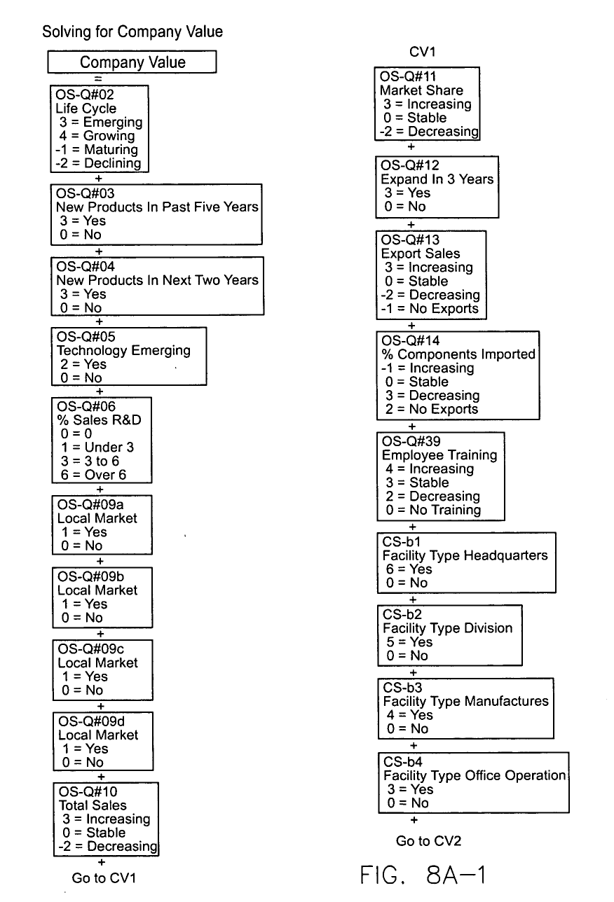

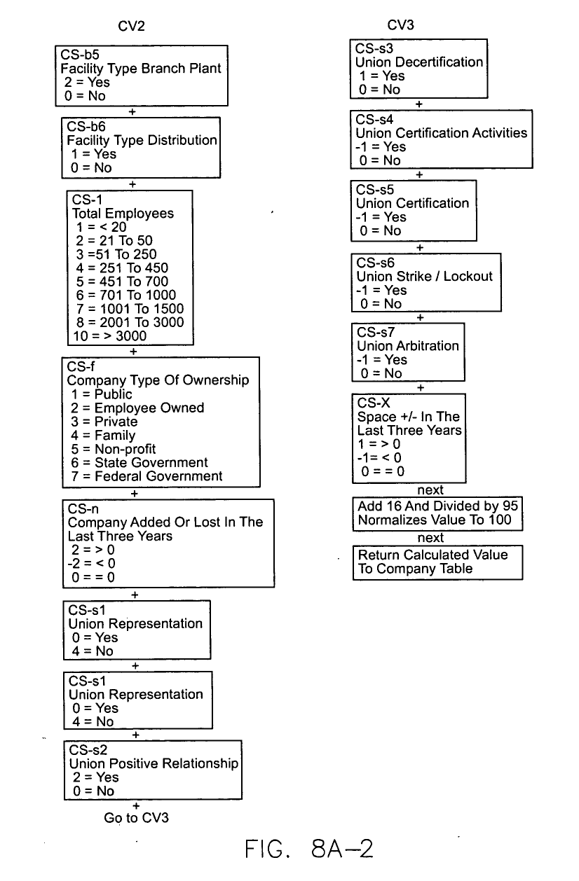

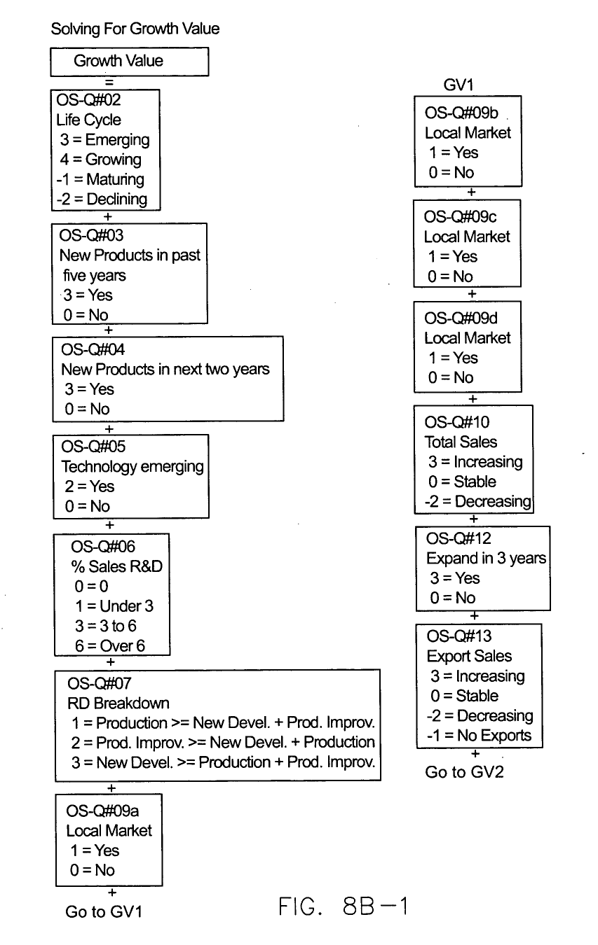

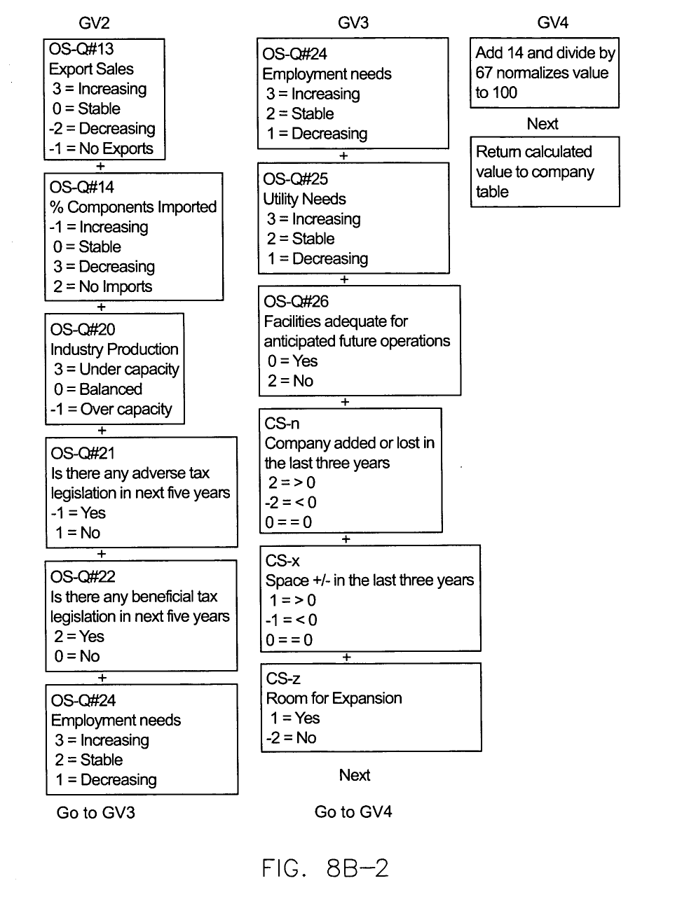

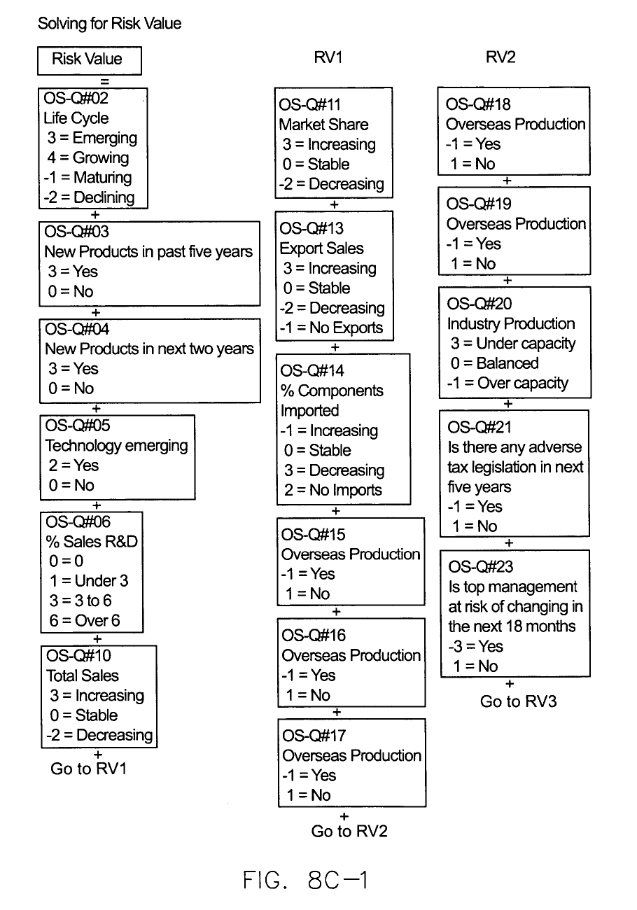

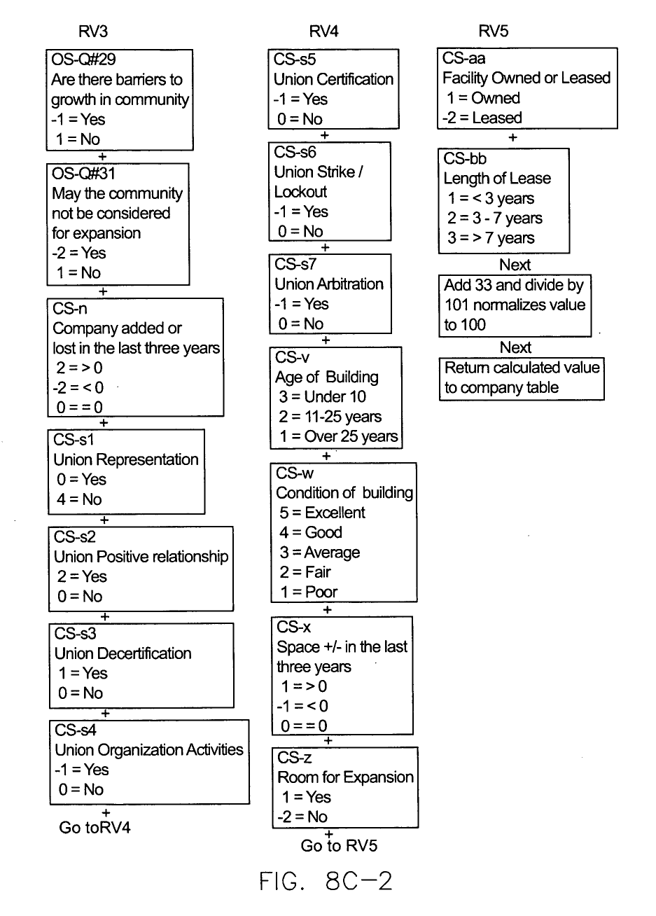

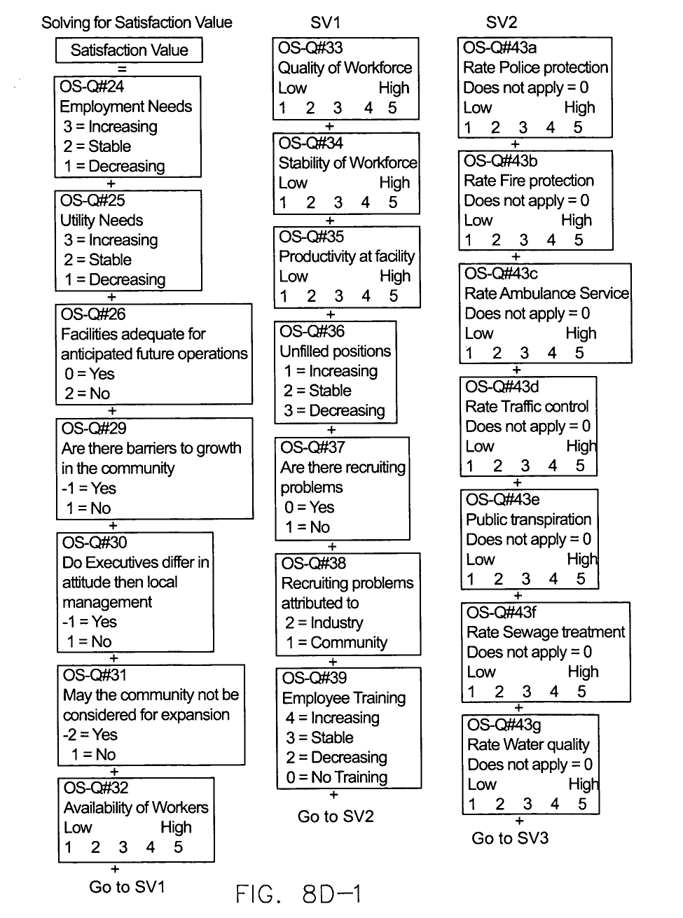

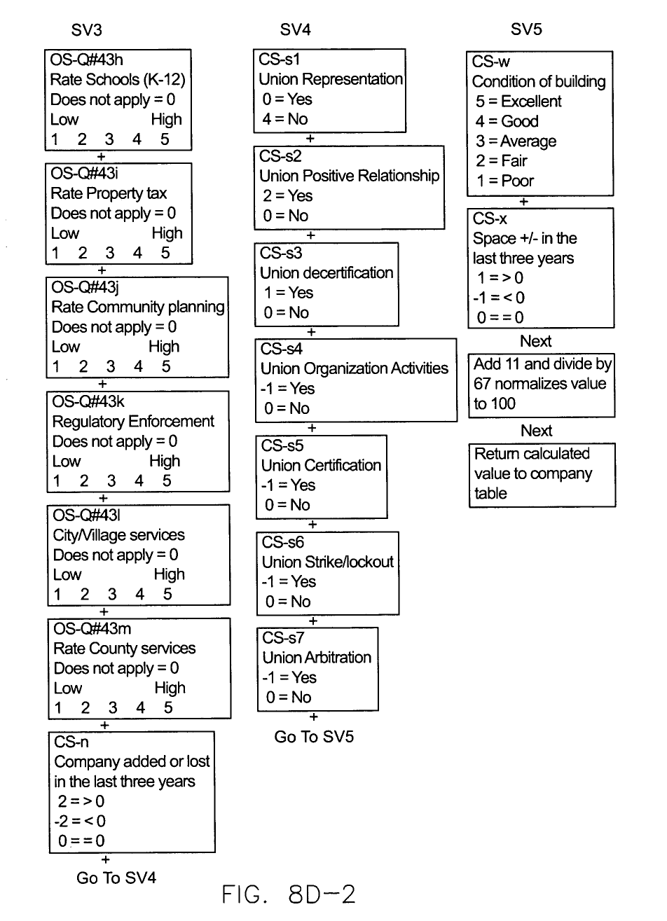

Referring to FIGS. 8A-8D, exemplary information inquiries and weight factors for the answers are shown. Referring to FIG. 8A, for example, analysis of the core characteristic company value considers answers from fifteen questions raised in the on site survey form (OS) and seventeen questions found in the background form (CS). Of course, other combinations of information inquiries can be used depending on the nature of the issues being investigated.

After responses are gathered for the information inquiries, the weight factors are aggregated that correspond the selected answers. After aggregating the weight factor values corresponding to the responses, an aggregated total with a minimum value of −16 to a maximum value of +79 occurs for the core characteristic. Thereafter, the aggregated total is normalized to, for example, a range of 0 to 100 percent, so that different core characteristics are viewed on the some scale. To normalize the aggregated weight factors the following equations are preferred:
normval=Int(((aggamt+adjust)/highamt+adjust)*100)
   where normval is the normalized aggregated total of 0 to 100 percent;
aggamt is the total aggregation of weight factors;
adjust is an integer that sets the minimum total value to zero; and
highamt is the maximum total value that is possible.
   Thus, a high normalized value, e.g., 90-100, indicates that the company is very valuable to the community, and a low normalized value indicates the company adds little value to the community. Referring to FIGS. 8B-8D, this analysis repeats for each of the core characteristics.

Referring back to FIG. 2, after the normalized values are computed for all of the core characteristics, reports are generated (block 16). The reports include a company report (block 18), a major employers report (block 20), a business directory report (block 22), and other reports including a labor analysis report, a business change report and an early warning report. The reports utilize conclusions drawn from the matrix analysis of the present invention and information contained on the on site visit report form, the background report form and the post interviewing report form.

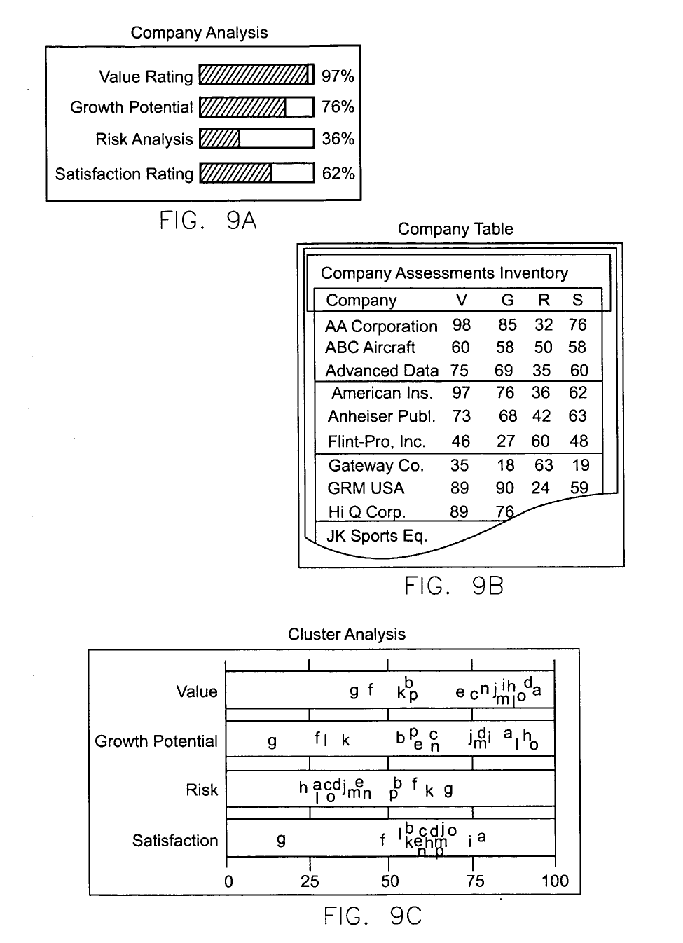

Referring to FIG. 9A-9C, exemplary analysis reports are shown. Referring to FIG. 9A, a bar chart shows results of the matrix analysis calculations for the four exemplary core characteristics, e.g., value rating, growth potential, risk analysis and satisfaction rating. Since the results were normalized, the results are shown as a percentile, a bar being black up to the level of the value calculated for the subject, e.g., the company. The remainder of the bar is blank to the total of 100, and the percentile number is shown adjacent to the bar.

Referring to FIG. 9B, a company table is shown which list the subjects, for example, in alphabetical order, and identifies the companies' percentile rating for each core characteristic. In addition, the company table can be sorted by each of the core characteristics, e.g., value, growth, risk and satisfaction. Referring to FIG. 9C, a cluster analysis is shown. The letters located in the bar indicate the different companies, and the position of the letters in a bar indicates the percentile rating for that company corresponding to the core characteristic. When a high number of companies are involved, the cluster analysis is replaced by the company table (FIG. 9B) sorted for each core characteristic, since the cluster analysis becomes unreadable.

FIG. 10 is a block-diagram of an exemplary system 1000 for gathering data for the cluster analysis, or, in another example, in preparation for a determination of a company's technology bias and a community's technology density. A user environment 1002 can include a user terminal 1004, such as a personal computer or other data entry device. The user terminal 1004 can connect to the Internet 1006, or other network, such as a local area network (LAN), wide area network (WAN) and regional networks such as commercial information services, via a firewall 1008. The user environment 1002 can be used to input information gathered from participants that complete questionnaires in response to a user initiated information collection process 1010. Alternatively, the participants can each enter their own information directly, such as via the Internet 1006.

The Internet 1006 can be used to connect the user environment to a software environment 1012. The software environment 1012 can include one or more servers 1014 that can include output devices such as displays and printers, processors, memory 1016, and input devices such as a keyboard. A software application 1018 can be used to analyze, such as the in the ways described below, the data stored in memory 1016. The servers 1014 can connect to the Internet 1006 via firewalls 1020, one or more switches 1022 and routers 1024, such that information collected during the collection process 1010 can be sent to the servers 1014 and analyzed.

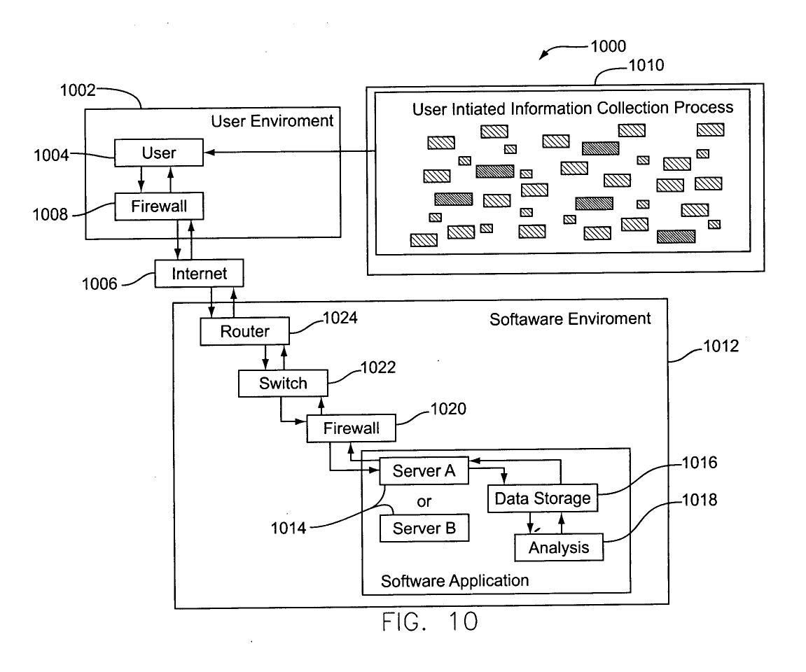

FIG. 11 is a block diagram showing one way that communities can view companies within the community based on information gathered from the collection process 1010. The companies can be divided by size, such as small companies 1100 having about 2 to 15, mid-sized companies 1102 having about 16-250 employees, and large companies 1104 having about over 251 employees. The communities could also organize the companies in other ways, such as by the amount of revenue they bring to the community, the business sector, geographic location and membership. Communities can make decisions such as how to allocate resources, based on such an organization of the companies.

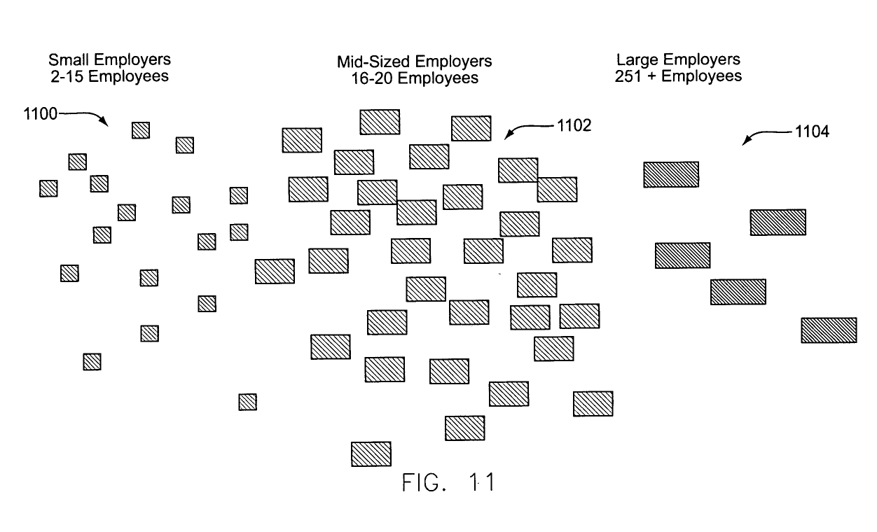

FIG. 12 is a block diagram of another way that a community can organize companies within the community based on information gathered from the collection process 1010. The collected information can be analyzed to determine the company's technology bias, also known as technology orientation. Technology bias can be used to describe the company's ability to absorb and/or produce technology, or to show the company's adversity to technology. This bias can be expressed in a variety of management and business practices of the company, which can be determined by presenting questions to the company.

The company's technology bias can range from being related to the primary source of the company's competitive advantage, to the company not being interested in either incorporating technology from other companies into their products or producing technology of their own. For example, companies that produce their own technology are like INTEL which produces processors, and companies that incorporate or absorb technology into their own products include the toaster manufacturing company that utilizes INTEL chips in their toasters. Companies that may not be interested in technology include companies that produce oil which are not interested in either incorporating or producing new technology. Companies having such similar orientations can be grouped together, such as small companies grouped by similar orientation 1202a-d, mid-sized companies grouped by similar orientation 1204a-d, and large companies grouped by similar orientation 1206a-b.

An understanding of the company's technology bias can be important to communities where the company is located for several reasons. In some cases, a single company's technology bias can change the public perception of an entire community, such as DELL located in Austin, Tex. and MICROSOFT located in Redmond (Seattle), WA. In this case MICROSOFT affects the perception of the region. Technology density, the concentration of companies in each community or other technology bias sector, can be determined from technology bias. Knowledge of the community's technology density can be a powerful tool used to push for economic growth within that community. Moreover, technology bias and technology density can have an impact on the community's current and future economy. It can also be determined whether the company's technology bias can subject the company to business risks with a potentially dramatic negative economic impact on the community. Understanding these factors can allow resources can be allocated appropriately.

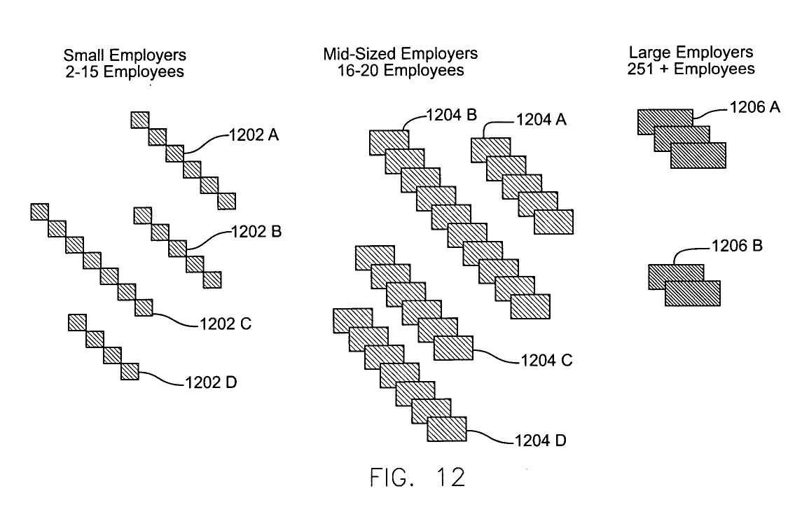

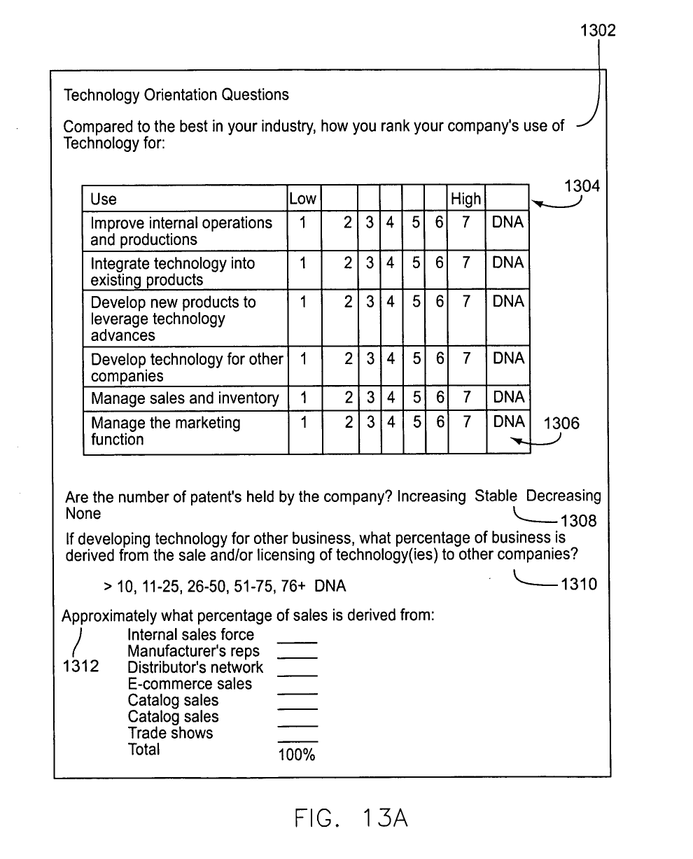

FIGS. 13A and 13B show a questionnaire showing exemplary questions, related to a company's technology production, technology utilization and technology absorption, which can be asked to help determine a company's technology bias. The questionnaire includes questions related to topics such as how the company would rank their use of technology 1302. The question can be related to a chart 1304 that lets the company rate from 1 being low to 5 being high, how they use technology to improve internal operations and productions, integrate technology into existing products, develop new products to leverage technology for other companies, manage sales and inventory and manage the marketing function. The chart also includes a column 1306 that lets the company indicate that the particular question does not apply.

Other questions relate to the companies patent holdings 1308, such as whether the holdings are increasing, stable, decreasing or non-existent. It is determined what percentage of business is derived from the sale and/or licensing of technology to other companies, such as less than 10, 11 to 25, 26 to 50, 51 to 75 or more than 76 percent. It can also be determined what percentage of sales is derived from internal sales force, manufacturer's representatives, distributor's networks, e-commerce sales, catalog sales and trade shows. Other questions include whether the company's e-business is increasing, stable, decreasing or does not apply 1314. It can be determined what percentage of sales the company spends on research and development (R&D) 1316, such as 0, 1-3, 3-6 and more than 6. It can also be determined as a percentage how the R&D budget is divided among new product development, product improvement and production improvements 1318. Other questions include whether the company has introduced new products, services and capabilities in the last five years 1320 and whether any new technology is emerging that will substantially change either the company's primary product or how it will be produced 1322. It can be determined whether the company's investment in employing training is increasing, stable, decreasing or non-existent 1324. It can also be determined, if there is training, what percentage of the training budget is for new job skills and what percentage is for remedial skills 1326, and what percentage of the employment is devoted to technology 1328, zero, less than 6, between 6 and 12 or greater than 12.

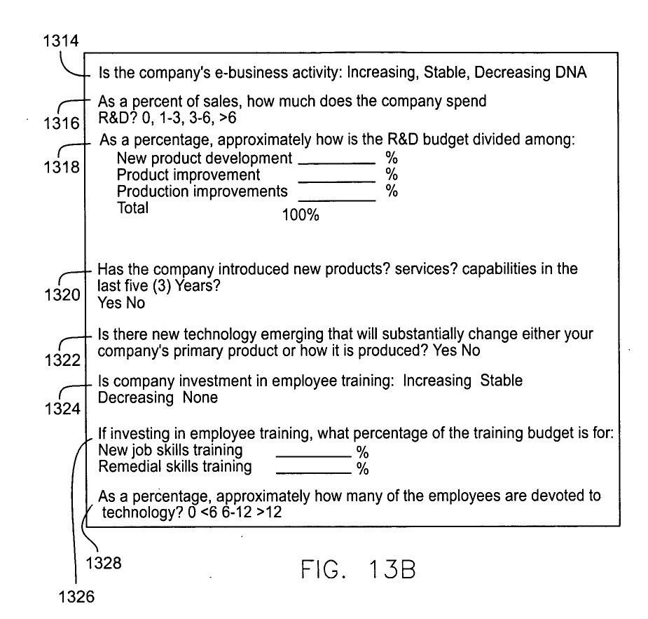

FIG. 14 is a chart showing an exemplary way to calculate the technology bias of a company. Production and/or management factors such as absorption and utilization, e.g., variables, are determined from the questions, such as the questions shown in FIGS. 13A and B. Referring to FIG. 14, the variables are chosen for technology production, the production of technology for use by other companies, technology absorption, the company's own incorporation of technology into products, services, productions and/or company operations, and technology utilization, the company's attitude toward the use of technology in the company. A variable ranking protocol (RP) 1401 is used to quantify the answers to the questions. The necessary information is gathered, such as with the information collection process 1010, and the answers to the variables for each company are qualified against an established norm, e.g., benchmarks 1450, 1452 and 1454.

In the present example, based on the answers to the different questions and the quantified values, for a particular question the company can be considered hyper-dynamic 1454, dynamic 1452 or amanic 1450. Hyper-dynamic companies create technology and provide it to other companies. Examples of such companies can include INTEL Corp. (processors), ABBOTT LABORATORIES (pharmaceuticals), ZEBRA TECHNOLOGY (bar code technology), RESEARCH IN MOTION (blackberry handheld devices) and MICROSOFT Corp. (software). Examples of hyper-dynamic communities can include metro Boston, Mass., Austin, Tex. and Palo Alto, Calif. Dynamic companies aggressively incorporate or absorb technology into operations, production, and products to achieve a competitive advantage. Such companies can include SCHNEIDER International (logistics) and UNILEVER HOME & PERSONAL CARE (Suave products). Examples of dynamic communities can include Tupelo, Miss., Chicago, Ill. and Kansas City, Kans. Amanic companies resist technology absorption and are slow to adapt to technology changes in their business sector, such as milk carton manufacturers. Such amanic companies can include US GYPSUM (construction materials like wallboard), JOHNS MANSVILLE (roofing shingles), or other sometimes small, thinly financed, and/or privately owned manufacturing companies. Examples of amanic communities can include Akron, Ohio, Green Bay, Wis., Fort Wayne, Ind., St. Louis, Mo., and Cheyenne, Wyo.

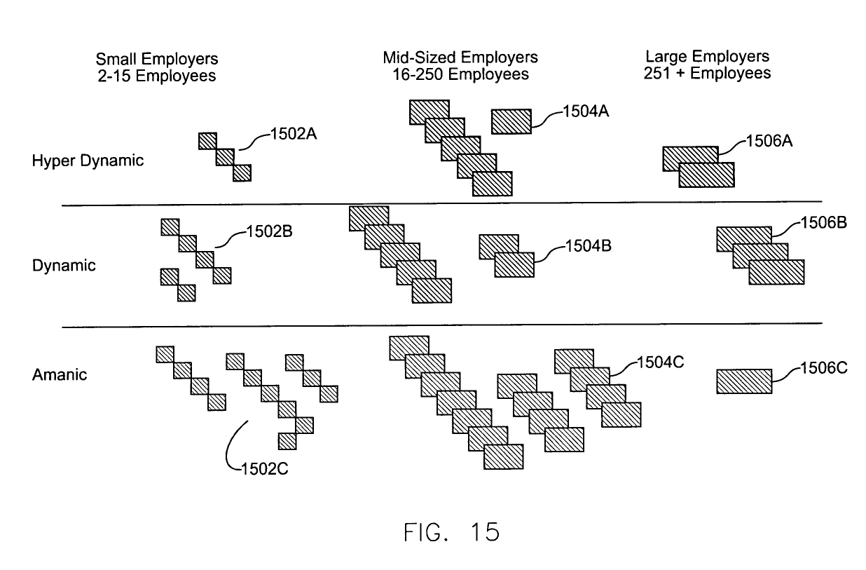

Net value 1456 is determined as the sum of the values for each particular benchmarks, e.g, amanic 1450, dynamic 1452 and hyper-dynamic 1454. Each benchmark can have a net value 1456. The net value 1456 for this particular example ranges from −14 to 30 for the amanic, −10 to 65 for the dynamic, and −10 to 81 for the hyper-dynamic. The net values 1456 can be normalized, for example, to a scale of 0 to 100, to be used in graphs such as the graphs described below with regard to FIGS. 16-19.

The questions 1400 listed FIGS. 13A and 13B can be analyzed in the chart of FIG. 14. The answers to the questions can be quantified. For example, the answers to questions Q1 through Q6 1402, can be quantified as an answer from one to seven depending on how the company ranked their use of technology compared to other companies. If the company did not answer (DNA), no value is given. The answer to the question Q7 1404 regarding the patents held by the company can be quantified as a value of three if the number of patents are increasing, zero if stable, negative 2 if decreasing and zero if the company has no patents. Regarding question Q8 1406, about the percentage of technology produced for other companies, less than 10 percent can be quantified as a 1, 11-25 percent can be quantified as a 2, 26-50 percent can be quantified as a 3, 51-75 percent can be quantified as a 4 and over 76 percent can be quantified as a 5. Regarding questions Q9 to Q14 1408, the percentage of sales derived from different sources can also be quantified, as shown. Regarding question Q15 1410, the company's e-business activity if considered increasing can receive a value 4, if considered stable can receive a value 2, if considered decreasing can receive a value negative 2 and if there is none, can receive a value 0. Regarding question Q16 1412, as a percentage of sales, the amount of R&D spent can be quantified as a 0 if none is spent, a 1 if one to three percent is spent, a 3 if four to six percent is spent and a 6 if greater than six percent is spent. Questions Q17-Q19 relate to how the R&D is divided among new product development, product improvement and production improvement. If new product development is receives greater than seventy percent, a value of 3 is obtained. If product improvement receives greater than sixty percent, a value of 2 is obtained. If production improvements received greater than forty percent, a value of 1 is obtained. Regarding question Q20 1416, if the company introduced new products or services within the last five years, a 3 is obtained, otherwise a 0. Regarding question Q21 1418, if a new technology has emerged that will substantially change the company's product or how it is produced, a 2 is obtained, otherwise a 0. Regarding question Q22 1420, if investment in employee training is increasing a 4 is obtained, is stable a 3 is obtained, if decreasing a 2 is obtained and is none a 0 is obtained. Regarding question Q23 1422, if the percentage of training for new job skills is less than thirty-five percent, a 0 is obtained, if between thirty-six and seventy-five percent, a 2 is obtained, and if greater than seventy-five percent, a 4 is obtained. Regarding question Q24, if technology employment is zero, a 0 is obtained, if less than six percent, a 2 is obtained, if between six and twelve percent, a 4 is obtained and if greater than twelve percent, a 6 is obtained.

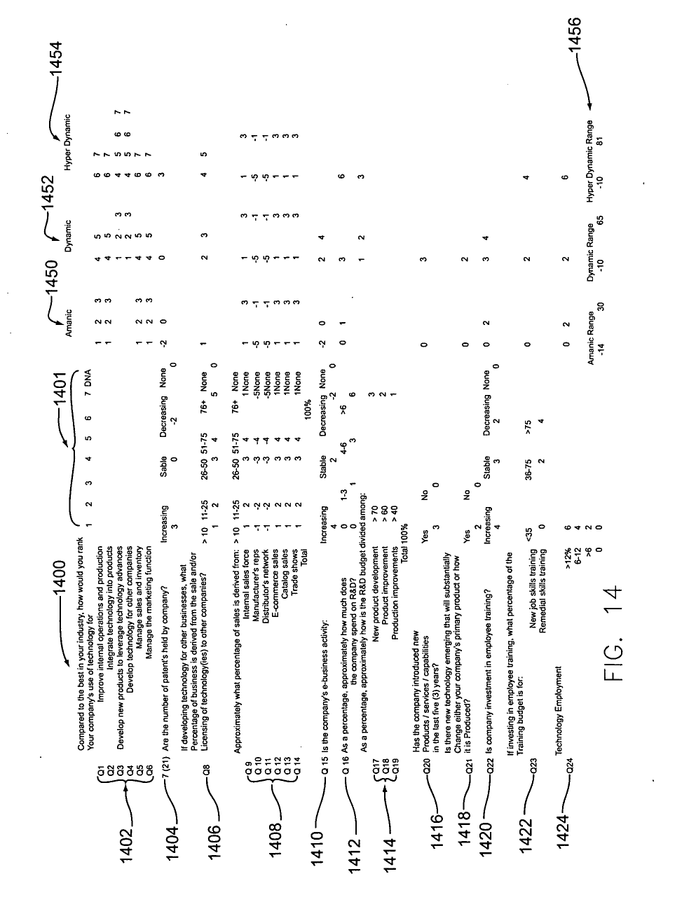

FIG. 15 is a block diagram showing a way that a community can organize companies within the community based on a size of the company and whether the company is mostly hyper-dynamic 1502a, 1504a, 1506a, dynamic 1502b, 1504b, 1506b, or amanic 1502c, 1504c, 1506c.

FIG. 16 is a graph showing the technology density for an exemplary community A. It should be understood, that while the graph shows the technology density for a particular community, the graph can also be used to show the technology density for other entities, such as for another type of geographical region, such as a county. The graph can also be used to show the technology bias for a particular company. The graph shows that community A has a generally balanced portfolio of companies within the community with a slight positive lean toward a more dynamic, technology absorbers, orientation. For example, on a scale of 1 to 100, if the dynamic companies averaged a score of 57, it could be shown at point A. If the hyper-dynamic companies averaged a score of 42 it could be shown at point B. And if the amanic companies averaged a score of 36, it could be shown at point C.

The technology density is calculated for a community as the average producers (companies with a hyper-dynamic tendency) ranking divided by the number of producers; the average absorption (dynamic companies) ranking divided by the number of absorbers; and the average amanic ranking divided by the number of amanics. The density:

| | | Average | |
|---|---|---|---|
| | Count | Ranking | Density |
| Absorbers | 21 | 57 | 57/21 = 2.7 |
| Producers | 37 | 42 | 42/37 = 1.1 |
| Amanics | 31 | 36 | 36/31 = 1.2 |
| | 89 or | | |
| | 100% | | |

shows an average orientation for the community, i.e., a technology absorbing community.

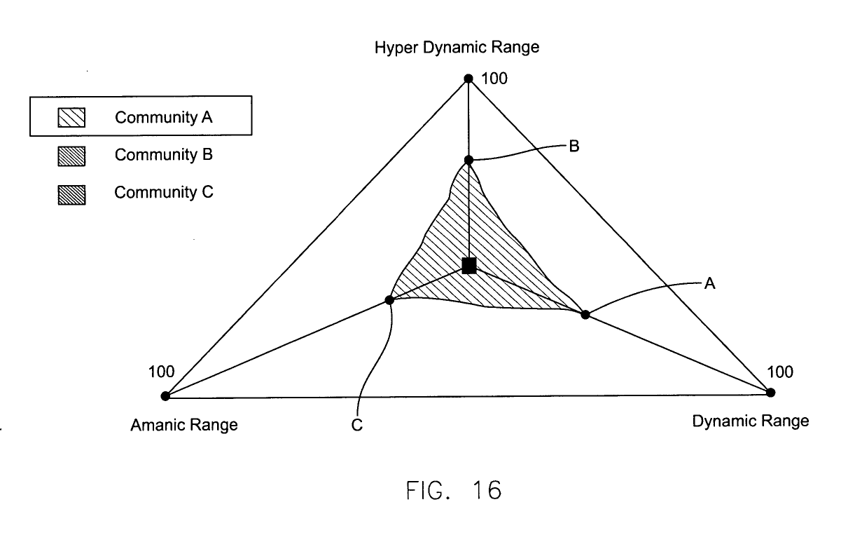

FIG. 17 is a graph showing the technology density for a particular community B. For community B the hyper-dynamic and amanic companies dominate in the community. The weak dynamic range reduces the overall balance.

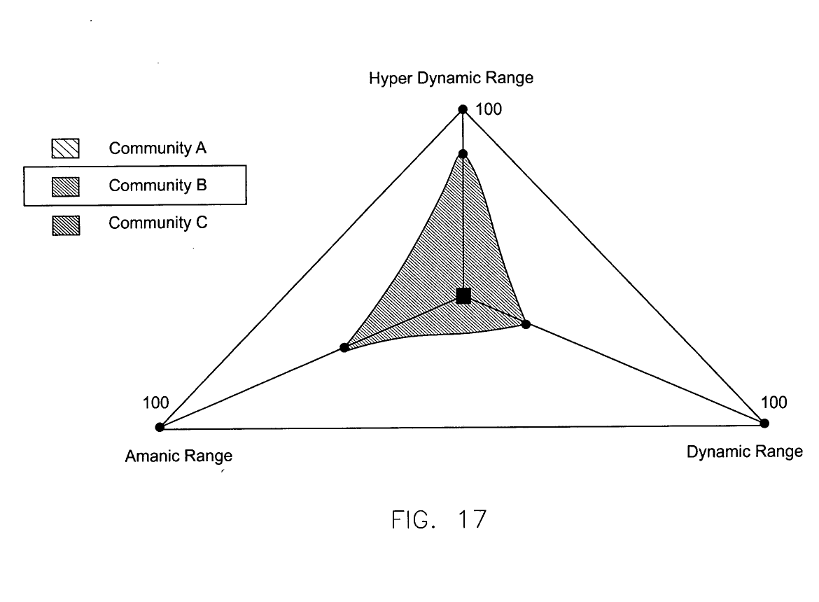

FIG. 18 is a graph showing the technology density for a particular community C. The graph shows an amanic company portfolio overwhelms the community perception. This can result in an ‘old manufacturing town’ bias. The weak hyper-dynamic and dynamic ranges reduce the potential of the community's economic engine.

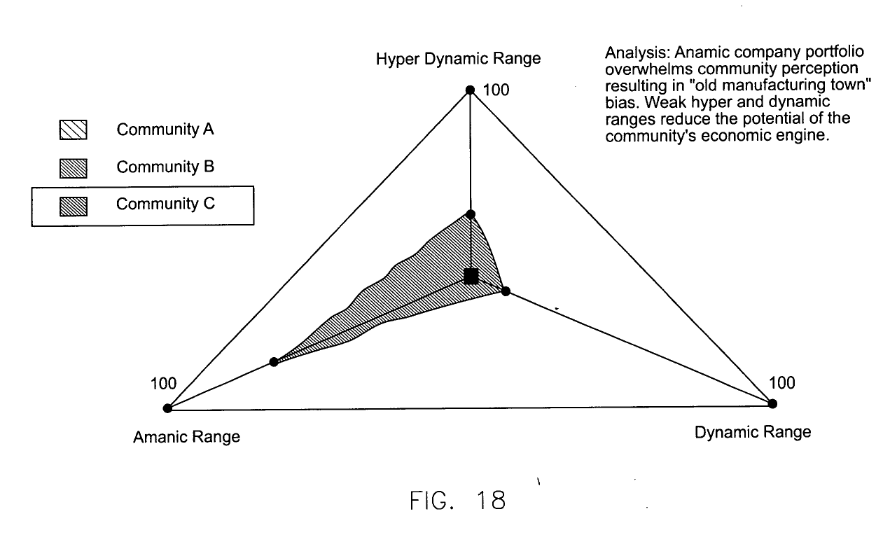

FIG. 19 is a graph showing a technology for a particular state or other geographic region, such as a county. The technology density for a state or region is the sum of the technology densities for all of the communities within the defined state or region. For example, if community A, community B and community C make up a particular county shown in FIG. 19, the technology density for the county is fairly well balanced but leans towards the amanic.

Understanding the technology bias and technology density can provide value to the community by allowing the leadership to understand an important dimension of their community's economic future. For example, such graphs could help communities like silicon valley become aware of a potential risk of having the bulk of companies in the hyper-dynamic range. In a global marketplace, understanding technology bias can be important for a community to compete globally from a higher cost location. Moreover, an analysis of technology density can help a community obtain funds, resources and attract other companies. In addition, if a community discovers that it is technology amanic, the community can implement training or other programs, such as technology awareness and technology sensitivity programs, for amanic firms.

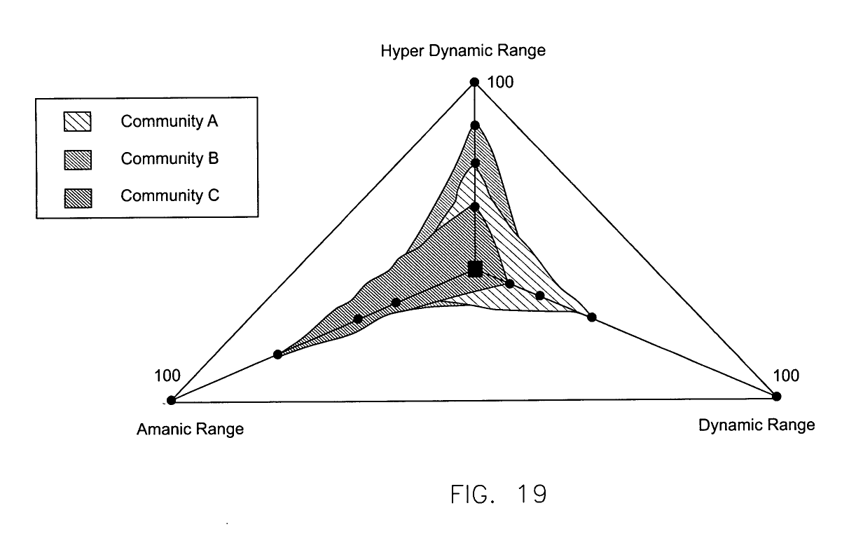

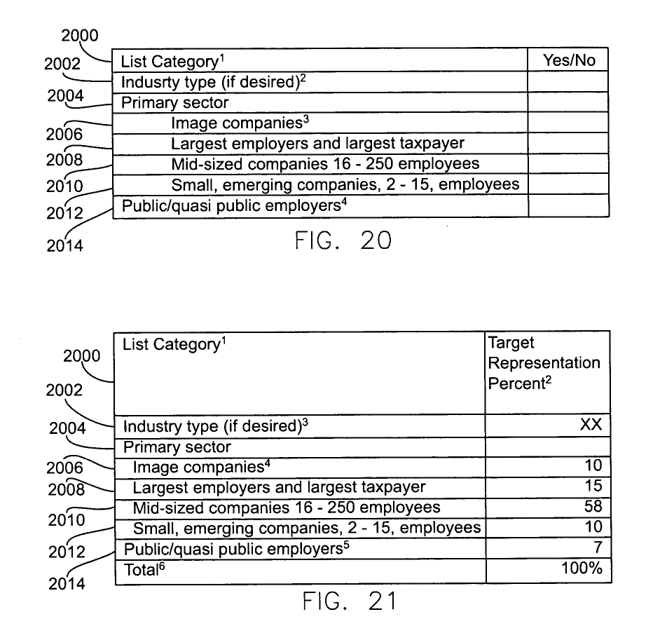

FIG. 20 is a chart showing an exemplary list of categories 2000 that can be used to select companies to be evaluated for their technology bias, to determine a technology bias index and technology density. Some of the categories may overlap. Those commissioning the analysis for the community can decide to select companies for the survey based on industry type 2002, if desired, such as cluster industries, manufacturing, company headquarters and commercial services. Cluster industries include companies that work together for a particular industry, such as in the automobile industry, related companies can include advertisers, accountants, consultants, fuel research labs, dealers, and companies that design and/or manufacturer seats or instruments panels. The information technology industry can include companies such as those in communications, software and hardware companies, and research institutions. The community can also have the analysis performed on primary sector companies 2004, such as image companies 2006, those companies that can be well known outside the community and can create positive impressions of the community. Companies can also be selected for the survey based on their size or tax base, from the largest 2008, to the mid-sized 2010, to the small 2012. Public or quasi public employers 2014 can also be chosen such as schools, hospitals, government facilities, and large non-private employers. The companies are then categorized by reviewing the list of companies and marking them as being in the primary sector or in the public or quasi-public sector, reviewing the company list for any companies with known high risk concerns, and reviewing the company list for each of the categories identified by the chart.

FIG. 21 shows a chart listing the target representation groups by a percentage. Some categories may overlap, such as the largest employer may also be an image company. When the number of categories exceeds the target representation, a random sample of the companies within the category can be selected. For example, from the companies used for the survey, 10 percent can be image companies, 15 percent can be large employers, 58 percent can be mid-sized employers 10 percent can be small, emerging companies, and 7 percent can be public or quasi-public employers. Of course, other percentages can be used. Typically, 80 percent, plus or minus 5 percent, of the companies listed are from the targeted industry sector.

From the foregoing description, it should be understood that an improved method of matrix analysis has been shown and described which has many desirable attributes and advantages. Conclusions for the core characteristics are represented by a number calculated using the matrix analysis of the present invention. By giving the core characteristic a numeric value, quick assessment of a subject becomes possible, as well as the subject's relationship to others in the group. Moreover, subjective information becomes objective benchmarks for comparison.

It is to be understood that changes and modifications to the embodiments described above will be apparent to those skilled in the art, and are contemplated. It is therefore intended that the foregoing detailed description be regarded as illustrative rather than limiting, and that it be understood that it is the following claims, including all equivalents, that are intended to define the spirit and scope of this invention.

1. A method for identifying a technology bias of a company located within a community, comprising:
quantifying a first information gathered regarding technology production, wherein technology production includes technology that relates to technology produced by the company;
quantifying a second information gathered regarding technology absorption, wherein technology absorption includes technology absorbed into at least one of a product and a service of the company;
quantifying a third information gathered regarding technology utilization, wherein technology utilization includes an attitude by the company regarding a use of technology; and
identifying the technology bias of the company in accordance with the quantified first information and the quantified second information.

2. The method of claim 1 further comprising calculating a technology bias index, wherein the technology bias index is calculated by comparing the identified technology bias for the company with an average technology bias calculated for a plurality of other companies.

3. The method of claim 2 wherein the technology bias index for the company establishes the company as being mostly one of a hyper-dynamic company, wherein the hyper-dynamic company at least one of creates technology and provides technology to other companies, a dynamic company, wherein the dynamic company absorbs technology into at least one of operations, production, and products, and an amanic company, wherein the amanic company resists both absorption, utilization and production of technology.

4. The method of claim 3 further comprising calculating a technology density for a community, wherein the technology density is determined by calculating an average ranking for the hyper-dynamic companies within the community, and average ranking for the dynamic companies within that community and an average ranking for the amanic companies within the community.

5. The method of claim 1 wherein the first information and the second information are determined from answers to a plurality of questions.

6. The method of claim 5 wherein in accordance with an answer for each question the company can be considered one of hyper-dynamic, dynamic and amanic in accordance to the answers to the questions, wherein hyper-dynamic comprises creating technology and providing technology to other companies, dynamic comprises absorbing technology into at least one of operations, production, and products, and amanic comprises resisting absorption, utilization and production of technology.

7. The method of claim 6 wherein an average of the hyper-dynamic responses, an average of the dynamic responses and an average of the amanic responses are charted on a generally triangular shaped graph.

8. The method of claim 1 wherein the community comprises at least one of a city, a county and a state.

9. A method for identifying a technology density of a plurality of companies located within a community, comprising:
identifying a technology bias of the company, wherein the technology bias comprises an indication of an amount of technology absorbed, utilized and produced by the company;
calculating a technology bias index, wherein the technology bias index is calculated by comparing the identified technology bias for the company with an average technology bias calculated for a plurality of other companies, and wherein the technology bias index for the company establishes the company as being mostly one of a hyper-dynamic company, wherein the hyper-dynamic company at least one of creates technology and provides technology to other companies, a dynamic company, wherein the dynamic company absorbs technology into at least one of operations, production, and products, and an amanic company, wherein the amanic company resists both absorption and production of technology;
calculating a technology density for a community, wherein the technology density is determined by calculating an average ranking for the hyper-dynamic companies within the community, and average ranking for the dynamic companies within that community and an average ranking for the amanic companies within the community.

10. The method of claim 9 further comprising obtaining answers to questions about a production, utilization and absorption about technology by the company.

11. The method of claim 10 wherein for each answer by the company can be considered one of hyper-dynamic, dynamic and amanic in accordance to the answers to the questions, wherein hyper-dynamic comprises creating technology and providing technology to other companies, dynamic comprises absorbing technology into at least one of operations, production, and products, and amanic comprises resisting both absorption and production of technology.

12. The method of claim 11 wherein an average of the hyper-dynamic responses, an average of the dynamic responses and an average of the amanic responses are charted on a generally triangular shaped graph.

13. The method of claim 9 wherein the community comprises at least one of a city, a county and a state.
